(19) United States
(12) Patent Application Publication
(10) Pub. No.: US 2019/0286729 A1
(43) Pub. Date: Sep. 19, 2019

(54) METHOD AND DEVICE FOR ASSISTED DIAGNOSIS OF PROBLEMS IN APPLIANCES

(71) Applicant: WIPRO LIMITED, BANGALORE (IN)

(72) Inventors: Manjunath Ramachandra Iyer, Bangalore (IN); Meenakshi Sundaram Murugeshan, Bangalore (IN)

(21) Appl. No.: 15/935,697

(22) Filed: Mar. 26, 2018

(30) Foreign Application Priority Data
Mar. 18, 2018 (IN) 201841009874

(51) Int. Cl. G06F 17/30

(52) U.S. Cl. CPC G06F 17/30398; G06F 17/30864; G06F 17/3056

(57) ABSTRACT

The present disclosure discloses a method and device for diagnosing problems in appliances. The device may receive a user input describing a problem related to an appliance. Further, the device extracts one or more objects from the user input for determining at least one effect of the problem and determines a problem domain based on the one or more objects. Further, the device retrieves a plurality of causes from the problem domain leading to the at least one effect. Furthermore, the device instructs user to perform at least one action and analyses user observations to determine an actual cause of the problem from the plurality of causes, for diagnosing the problem in appliances. The method and device of the present disclosure diagnoses problem in appliances by interacting with the user in real time.

### TECHNICAL FIELD

The present disclosure relates to virtual assistance. More particularly, but not exclusively, the present disclosure relates to a method and an assistance device for providing real-time assistance to diagnose problems in appliances.

### BACKGROUND

An assistance mechanism is a combination of processes that receives user inputs pertaining to problems faced by a user and provides assistance to fix the problems. Existing assistance devices receives user inputs, processes the user inputs, searches and retrieves the required troubleshooting steps to fix the problem faced by the user. The troubleshooting may comprise a step by step instructions for solving specific problems. The step by step instructions may be accessed through various forms like troubleshooting manuals, virtual assist or in form of a human expert providing instructions remotely. Further, the user may have to seek help of a human technical assistant in order to diagnose the problem. Thus, the existing assistance mechanism may be expensive and result in loss of resources and time.

Currently, the user may seek help of a technical assistant to execute the troubleshooting steps either by the technical assistant visiting the user site or guiding the user remotely. For example, consider a scenario where a user faces a problem while interacting with an appliance. The user seeks help of the technical assistant. The technical assistant may visit the user site and perform a few actions on the appliance for diagnosing the problem. Thus, the user may always require a technical assistant to diagnose a problem, thereby resulting in wastage of time and resources. Further, the existing virtual assistance mechanisms may only provide pre-defined troubleshooting steps to be performed by the user. Thus, the problem faced by the user may not be resolved as the assistance mechanism does not determine the actual cause of the problem before providing the troubleshooting steps.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a method for assisted diagnosis of problems in appliances. The method may include receiving, by an assistance device, a user input describing a problem related to an appliance. Further, the method may include extracting one or more objects from the user input. At least one effect of the problem may be determined based on the one or more objects. Further, the method may include determining a problem domain from a plurality of problem domains based on the one or more objects, retrieving a plurality of causes from the problem domain leading to the at least one effect. Further, the method may include instructing user to perform at least one action related to the appliance corresponding to at least one of the plurality of causes. User observations may be received upon completion of the at least one action. Further, the method may include analysing the user observations for determining a cause from the plurality of causes corresponding to the at least one effect, for diagnosing the problem in appliances.

In an embodiment, the present disclosure discloses an assistance device for diagnosing problems in appliances. The assistance device may include a processor; and a memory, communicatively coupled with the processor, storing processor executable instructions, which, on execution causes the processor to receive a user input describing a problem related to an appliance. Further, the processor may extract one or more objects from the user input. At least one effect of the problem is determined based on the one or more objects. The processor further may determine a problem domain from a plurality of problem domains based on the one or more objects. Further, the processor may retrieve a plurality of causes from the problem domain leading to the at least one effect. Thereafter, the processor may instruct the user to perform at least one action related to the appliance corresponding to at least one of the plurality of causes. The user observations may be received upon completion of the at least one action. Further, the processor may analyse the user observations for determining a cause from the plurality of causes corresponding to the at least one effect, for diagnosing the problem in appliances.

In an embodiment, the present disclosure relates to a non-transitory computer readable medium including instruction stored thereon that when processed by at least one processor cause an assistance device to receive a user input describing a problem related to an appliance. The instruction may cause the processor to extract one or more objects from the user input. At least one effect of the problem is determined based on the one or more objects. The instruction may further cause the processor to determine a problem domain from a plurality of problem domains based on the one or more objects and retrieve a plurality of causes from the problem domain leading to the at least one effect. Thereafter, the instruction may further cause the processor to instruct user to perform at least one action related to the appliance corresponding to at least one of the plurality of causes. The user observations are received upon completion of the at least one action. Lastly, the instruction may further cause the processor to analyse the user observations for determining a cause from the plurality of causes corresponding to the at least one effect, for diagnosing the problem in appliances.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 shows a block diagram illustrative of an exemplary environment for diagnosing problems in appliances, in accordance with some embodiments of the present disclosure;

FIG. 2 shows an exemplary block diagram of an assistance device for diagnosing problems in appliances, in accordance with some embodiments of the present disclosure;

FIG. 3 shows an exemplary flow chart illustrating method steps for diagnosing problems in appliances, in accordance with some embodiments of the present disclosure;

FIG. 4 and FIG. 5 illustrate exemplary embodiments for diagnosing problems in appliances, in accordance with some embodiments of the present disclosure; and

FIG. 6 illustrates a block diagram of a general-purpose computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure relate to a method and device for diagnosing problems in appliances. A user of an appliance describes the problem to assistance device via a user input. The problem may be related to the appliance. Further, the assistance device processes the user input to extract one or more objects from the user input for determining at least one effect of the problem. In some embodiments, the one or more objects may be one or more keywords. Thereafter, the assistance device determines a problem domain to which the problem belongs to, based on the one or more objects. Furthermore, the assistance device retrieves a plurality of causes from the problem domain leading to the at least one effect.

Thereafter, the assistance device instructs the user to perform at least one action related to the appliance corresponding to at least one of the plurality of causes. Lastly, the assistance device analyses the user observations and determines a cause from the plurality of causes corresponding to the at least one effect, for diagnosing the problem in appliances. The device and method of the present disclosure diagnoses problem in appliances by interacting with the user in real-time.

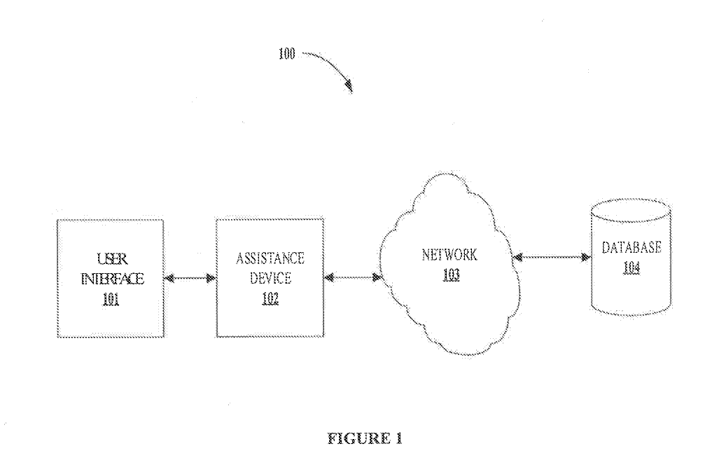

FIG. 1 shows a block diagram illustrative of an exemplary environment for diagnosing problems in appliances, in accordance with some embodiments of the present disclosure. The environment 100 includes a user interface 101, an assistance device 102, a database 104 and a network 103 which is connected to the assistance device 102 and the database 104. The user interface 101 may be capable of receiving the user input. The user input may be, but not limited to, a user query, generic statements, conversations of the user with the assistance device 102 and the like. The user input essentially describes a problem faced by the user. In general, the problem may be related to appliances. In an embodiment, the appliances may be an electrical equipment, electronic equipment or an electro-mechanical device, or any other equipment designed to perform a specific task.

In an embodiment, the user interface 101 may be a medium through which user input is received from the one or more users. In an embodiment, the user interface 101 may be a part of the assistance device 102 or as a separate unit. In an implementation, when the user interface 101 is a separate unit, it may be connected to the assistance device 102 via a wired or a wireless means. The user interface may include, but is not limited to, a keyboard, a keypad, a touchpad, a mike, a camera, a mouse, a microphone, a touchscreen, a joystick, a stylus, a scanner and any other medium which is capable of receiving the input from the one or more users.

In some embodiments, the assistance device 102 may be a computing system. The assistance device 102 may include, but is not limited to, computing systems, such as a laptop, a computer, a desktop computer, a Personal Computer (PC), a notebook, a smartphone, a smart watch, a wearable device, a tablet, e-book readers. A person skilled in the art would understand that the assistance device 102 may be configured on any other device, not mentioned explicitly in the present disclosure. In another implementation, the assistance device 102 may be configured as a standalone device or may be integrated with the computing systems.

The assistance device 102 may process the user input for diagnosing the problem faced by the user. Every problem may be defined by an effect and a cause. The effect of the problem is a result or outcome observed due to occurrence of the problem and the cause of the problem may be defined as a reason for the occurrence of the problem due to which the effect may be observed. The assistance device 102 may extract one or more objects from the user input for determining at least one effect of the problem. In one embodiment, the assistance device 102 may extract the one or more objects upon receiving a first user input. In another embodiment, the assistance device 102 may prompt the user to provide further user inputs to extract the one or more objects. Further, the assistance device 102 may generate queries to the user based on the user input and one or more objects are extracted using the response received from the user. The assistance device 102 may determine a problem domain from a plurality of problem domains, based on the extracted one or more objects.

The database 104 may include the plurality of problem domains. Each of the plurality of problem domains in the database 104 may relate to one or more appliances. Further, each of the plurality of problem domains may include information on problems related to each of the one or more appliances. Further, the information includes a plurality of causes corresponding to at least one effect. Thus, each domain may include a map between the plurality of causes and a corresponding at least one effect. The information on problems related to each of the one or more appliances further includes at least one action to be performed corresponding to the each of the plurality of causes. The at least one action may be a step to be performed by the user, the output of which is used by the system to determine the actual problem. The assistance device 102 may retrieve the plurality of causes from the determined problem domain, leading to the at least one effect. Further, the assistance device 102 may instruct the user to perform at least one action related to the appliance corresponding to at least one of the plurality of causes. Then, the assistance device 102 may receive the user observations upon completion of the at least one action. The at least one action performed by the user on the appliance helps the assistance device 102 to analyse the problem. In an embodiment, the assistance device 102 may monitor the user while the user performs the at least one action related to the appliance. In another embodiment, the assistance device 102 may receive further user inputs regarding the actions performed. Thereafter, the assistance device 102 may analyse the user observations for determining the actual cause from the plurality of causes corresponding to the at least one effect. In an embodiment, the assistance device 102 may update the database 104 based on experience and understanding of user behaviour and technology of the appliance. The user observations may be stored in the database 104 and may be retrieved during subsequent diagnosis.

In an embodiment, the assistance device 102 may communicate with the database 104 through the network 103. The assistance device 102 may be disposed in communication with the network 103 via a network interface (not shown). The network interface may employ connection protocols including, without limitation, direct connect, Ethernet (e.g., twisted pair 10/100/1000 Base T), transmission control protocol/Internet protocol (TCP/IP), token ring, IEEE 802.11a/b/g/n/x, etc. The network 103 may include, without limitation, a direct interconnection, wired connection, e-commerce network, a peer to peer (P2P) network, Local Area Network (LAN), Wide Area Network (WAN), wireless network (e.g., using Wireless Application Protocol (WAP)), the Internet, Wireless Fidelity (Wi-Fi), etc.

In an embodiment, the one or more appliances may include, but are not limited to, a television, a mixer, a grinder, a radio, a scanner, a printer, a multi-function printer, an electric motor, a microwave oven, an air conditioner, a washing machine, a gas fireplace, a cooler and the like.

In an embodiment, where the user input to the assistance device 102 may be “Mixer not working, getting a burning smell”. The assistance device 102 determines that the problem domain is “mixer-grinder” and the at least one effect of the problem is “burning smell”. The database 104 may have a list of effects pertaining to the problem domain “mixer-grinder”. The list of effects may be one of, but is not limited to, burning smell, motor is not rotating, jammed blades of jar, damage of electric wire and the like. Further, the database 104 may include the plurality of causes pertaining to each effect from the list of effects. In the above-mentioned embodiment, the effect is “burning smell”. The database 104 may have the plurality of causes leading to the effect of “burning smell”. In an example, the plurality of causes may be “coil burning” and “washer burning”.

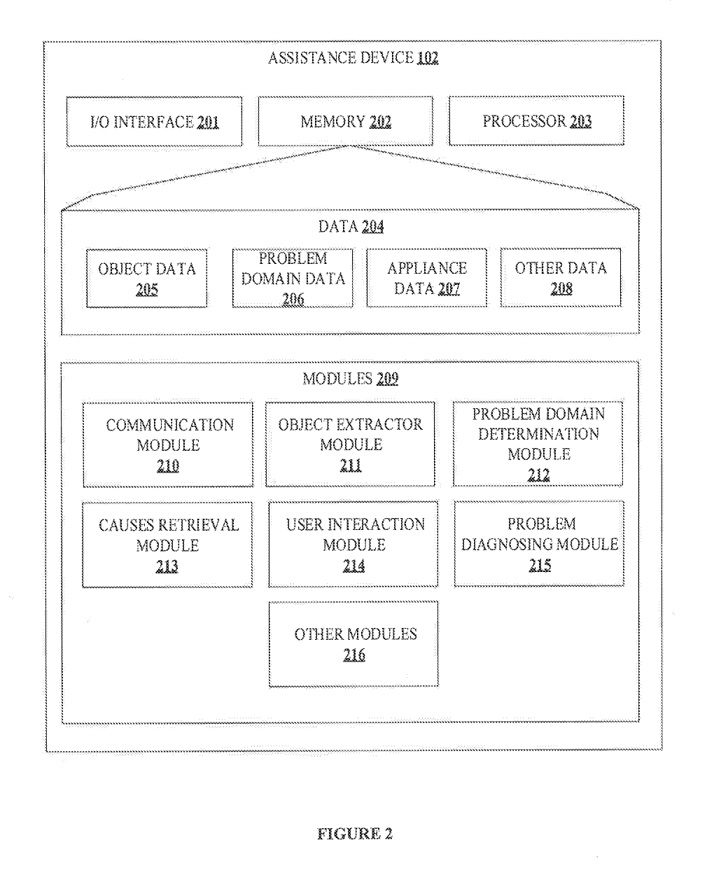

FIG. 2 shows an exemplary block diagram of an assistance device for diagnosing problems in appliances, in accordance with some embodiments of the present disclosure. The assistance device 102 may include at least one processor 203 and a memory 202 storing instructions executable by the at least one processor 203. The processor 203 may include at least one data processor for executing program components for executing user or system-generated requests. The memory 202 is communicatively coupled to the processor 203. The assistance device 102 further includes an Input/Output (I/O) interface 201. The I/O interface 201 is coupled with the processor 203 through which an input signal or/and an output signal is communicated. In an embodiment, the I/O interface 201 couples the user interface 101 to the assistance device 102.

In an embodiment, data 204 may be stored within the memory 202. The data 204 may include, for example, object data 205, problem domain data 206, appliance data 207 and other data 208.

In an embodiment, the object data 205 may include the one or more objects extracted from the user input. In an embodiment the user input may be in form of a text, a speech, an image, an audio, a video, a gesture, graphics and the like. In an embodiment, the user input is converted into text format by the assistance device 102 before processing the user input. The one or more objects extracted from the user input may include at least one keyword. In an embodiment, the one or more objects may also include image frames. In an embodiment, if the user input is “Mixer not working, getting a burning smell”, the one or more objects may be “mixer” and “burning smell”. Further, at least one effect of the problem is determined based on the one or more objects. In the above-mentioned embodiment, the at least one effect is “burning smell”. In an embodiment, the user may have seen a spark inside a microwave oven. The user may provide an image of the microwave depicting the above-mentioned problem. The object data 205 may include image frames of a microwave oven and corresponding descriptor as “microwave oven”. The assistance device 102 may extract a frame from the image provided by the user and the one or more objects extracted from the user input in the form of text may be “microwave oven” and “spark”.

In an embodiment, the problem domain data 206, may refer to a list of problem domains. Each of the problem domains relates to a particular appliance.

In an embodiment, the appliance data 207, may refer to the at least one effect of the problem specific to the appliance. The appliance data 207 may also include plurality of causes pertaining to the at least one effect and all actions that may be performed on the appliance.

In an embodiment the other data 208 may include, but is not limited to, historical data pertaining to the user. The historical data may include data regarding the previous problems faced by the user, the diagnostic steps instructed to the user, previous user inputs, results and/or responses provided to the previous user input, the one or more objects used in the previous user inputs, previous mappings used for a particular object or image used in the past, etc.

In an embodiment, the data 204 in the memory 202 is processed by modules 209 of the assistance device 102. As used herein, the term module refers to an application specific integrated circuit (ASIC), an electronic circuit, a Field-Programmable Gate Arrays (FPGA), Programmable System-on-Chip (PSoC), a combinational logic circuit, and/or other suitable components that provide the described functionality. The modules 209 when configured with the functionality defined in the present disclosure will result in a novel hardware.

In one implementation, the modules 209 may include, for example, a communication module 210, an object extractor module 211, a problem domain determination module 212, a causes retrieval module 213, a user interaction module 214, a problem diagnosing module 215 and other modules 216. It will be appreciated that such aforementioned modules 209 may be represented as a single module or a combination of different modules.

In an embodiment, the communication module 210 may receive the user input from the I/O interface 201. The user input may be in the form of text, speech, image, audio, video, gesture, graphics and the like.

In an embodiment, the object extractor module 211 may parse the user input and extract one or more objects from the user input. In an embodiment, the user input is essentially converted into text format by the assistance device 102 before processing the user input. Thereby, the one or more objects extracted from the user input may include one or more keywords. Consider a first instance, if the user input is “Issue in television, appearance of blue screen”, the assistance device 102 parses the user input to generate one or more objects. The one or more objects extracted may be “television” and “blue screen”. At least one effect of the problem is determined from the extracted one or more objects. Considering the first instance, “blue screen” is considered as the effect of the problem faced by the user.

In an embodiment, if the user input is in the form of the image, video, gestures, graphics without any audio or text input describing the problem, the object extractor module 211 makes use of multi-label classifier to map the image frames to pre-defined entities or parts.

In an embodiment, the object extractor module 211 may generate queries to the user based on the user input for extracting one or more objects from the user input.

In an embodiment, the problem domain determination module 212, may determine the problem domain of the user input based on the extracted one or more objects. In an embodiment, the problem domain determination module 212 identifies “television” as the problem domain. The determined problem domain is further used for determining the actual cause of the problem.

In an embodiment, the causes retrieval module 213 may retrieve the plurality of causes from the problem domain leading to the at least one effect. The plurality of causes may be retrieved from the database 104. In an embodiment, the database 104 may be present in the assistance device 102. Considering the first instance, the at least one effect determined is “blue screen”. Further, the assistance device 102 traverses the problem domain of “television” to retrieve the plurality of causes leading to the determined at least one effect “blue screen”. The database 104 may have the plurality of causes leading to the effect of “blue screen”. In an example, the plurality of causes retrieved may be “power supply issue” and “internal Integrated Circuit (IC) issue”.

In an embodiment, the user interaction module 214 may instruct the user to perform at least one action related to the appliance corresponding to at least one of the plurality of causes. The instructions provided to the user may be one of queries generated by the interaction module 216, addressed to the user and series of instructions provided to the user.

The instructions are provided to the user based on one of at least one effect determined from the user input and a plurality of causes retrieved from the problem domain leading to the at least one effect. The instructions provided to the user may be retrieved dynamically from the database 104. Based on the instructions provided to the user, the user performs at least one action related to the appliance.

In an embodiment, the problem diagnosing module 215 may analyse the user observations for determining the actual cause of the problem from the plurality of causes corresponding to the at least one effect.

In an embodiment, the other modules 216 may include, but are not limited to, a troubleshooting module, a desired response generator module, a display module, and a feedback module. The desired response generator module may be used to determine a desired response of the user input. In order to determine the desired response, conversation context and sentence structure of the user input may be considered.

In an embodiment, the troubleshooting module may be used to provide troubleshooting steps to the user, once the actual cause of the problem is determined by the problem diagnosing module 215. The troubleshooting steps may be a set of steps to be followed by the user to resolve the problem.

In an embodiment, the display module may be used to display the queries generated based on the user input, the instructions provided to the user for performing at least one action related to the appliance and for receiving the user observations upon completion of the at least one action. The display module may be one of, but not limited to a monitor, a Liquid Crystal Display (LCD), a Light Emitting Diode (LED) display and/or any other module which is capable of displaying an output. In an embodiment, the display module may be integrated with the assistance device.

In an embodiment, the feedback module may receive feedback from each of the one or more users when the actual cause of the problem determined by the assistance device 102 is inappropriate. In such scenario, the user may provide additional data describing the problem in a detailed manner. In an embodiment, the feedback module may receive feedback from each of the one or more users when the actual cause of the problem is accurately determined by the assistance device 102.

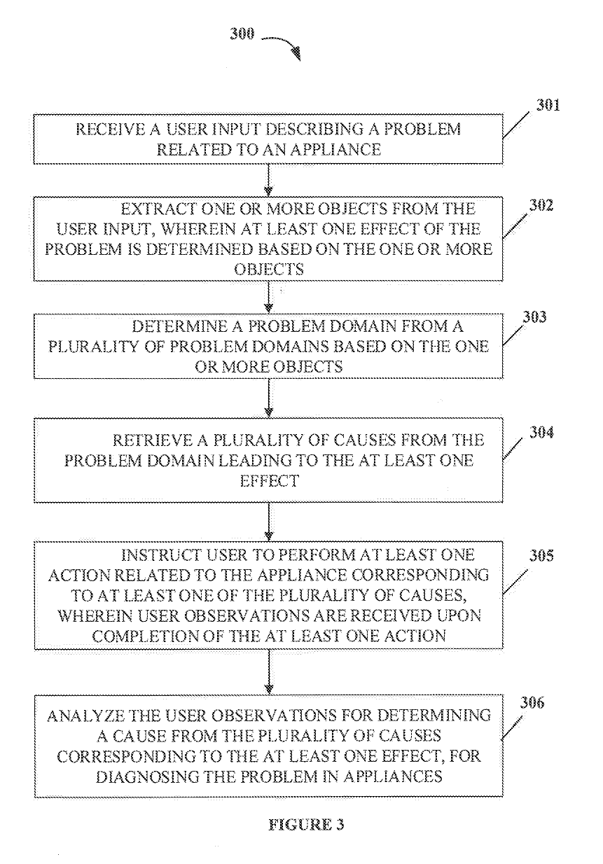

FIG. 3 shows an exemplary flow chart illustrating method steps for diagnosing problems in appliances, in accordance with some embodiments of the present disclosure;

As illustrated in FIG. 3, the method includes one or more blocks for diagnosing problems in appliances. The method 300 may be described in the general context of computer executable instructions. Generally, computer executable instructions may include routines, programs, objects, components, data structures, procedures, modules, and functions, which perform particular functions or implement particular abstract data types.

The order in which the method 300 is described is not intended to be construed as a limitation, and any number of the described method blocks may be combined in any order to implement the method. Additionally, individual blocks may be deleted from the methods without departing from the scope of the subject matter described herein. Furthermore, the method may be implemented in any suitable hardware, software, firmware, or combination thereof.

At step 301, the user input may be received by the communication module 210. The user input may be, but not limited to, user query, generic statements, conversations of the user with the system or other humans, and the like. The user input essentially describes the problem faced by the user. The problem may be related to appliances. The user input may be received from the one or more users. In an embodiment, the one or more users may be a person or a computing system. The user input may be in the form of text, speech, image, audio, video, gesture, graphics and the like.

At step 302, the object extractor module 211 may extract one or more objects from the user input. The object extractor module 211 may parse the user input and extract one or more objects from the user input. In an embodiment, the user input is essentially converted into text format by the assistance device 102 before processing the user input. Thereby, the one or more objects extracted from the user input includes one or more keywords. Consider a second instance, if the user input is “Mixer not working, getting a burning smell”. The assistance device 102 parses the user input to generate one or more objects. The one or more objects extracted may be “mixer” and “burning smell”. At least one effect of the problem is determined from the extracted one or more objects. Considering the second instance, “burning smell” is considered as the effect of the problem faced by the user.

In an embodiment, if the user input is in the form of the image, video, gestures, graphics without any audio or text input describing the problem, the object extractor module 211 makes use of multi-label classifier to map the image frames to pre-defined entities or parts. In an embodiment, images of gestures and frames of video are converted into features using a Convolutional Neural Network (CNN). The CNN is trained with several images of gestures and frames of videos. In an embodiment, where the user provides an input of a video of a problem associated with a washing machine to the assistance device 102. The assistance device 102 may extract frames from the video. The object extractor module 211 may convert the image frames into features. Further, the object extractor module 211 may extract the descriptors corresponding to the extracted features and determine the at least one object as “washing machine”. The features may be mapped onto descriptors using a Long Short-Term Memory (LS™) network. Further, the object extractor module 211 may employ association mining to extract corresponding objects or keywords and actions associated with the descriptors, entities or parts. Thereafter, the object extractor module 211 may use Natural Language Generation (NLG) technique to interpret the user input, in the form of text, for further processing. The assistance device 102 may support different multimedia formats, like image or video but finally the object extractor module converts the user input in any form to the text format for extracting one or more objects.

In an embodiment, the object extractor module 211 may further include generating queries to the user based on the user input for extracting one or more objects from the user input. The object extractor module 211 may generate queries to the user if the user has not defined the problem in an adequate manner. The queries may be generated adaptively. In an embodiment, where the user input is “there was fire”. In such an instance, the assistance device 102 immediately probes a query “where was the fire”, to the user. Based on the user response object extractor module 211 may generate the one or more keywords. In another embodiment, if the user input is “there was a fire in the washer of the jar”, the object extractor module 211 need not probe any query to the user for extraction of one or more objects. In the above-mentioned embodiment, the object extractor module 211 directly extracts one or more objects from the user input. The object extractor module 211 may generate the queries in the form of text or audio.

At step 303, the problem domain determination module may determine the problem domain from the plurality of problem domains based on the one or more objects extracted. The problem domain determination module 212, may determine the problem domain of the user input based on the extracted one or more objects. Considering the second instance, the problem domain determination module 212 identifies “mixer” as the problem domain. The determined problem domain is further used for determining the actual cause of the problem.

At step 304, the causes retrieval module 213 may retrieve the plurality of causes from the problem domain leading to the at least one effect. Considering the second instance, the at least one effect determined is “burning smell”. Further, the causes retrieval module 213 may traverse the problem domain of “mixer” to retrieve the plurality of causes leading to the determined at least one effect “burning smell”. The database 104 may have the plurality of causes leading to the effect of “burning smell”. The plurality of causes retrieved may be “coil burning” and “washer burning”. A cause-effect relation graph may be retrieved from the database 104 based on the at least one effect determined. The cause-effect relation graph may be generated using Natural Language Generation (NLG), Recurrent Neural Network/Long Short-Term Memory (RNN/LSTM). The cause-effect relation graph indicates a link between the effect and possible causes of the effect based on pre-learning and stored data in the database 104. The cause-effect relation graph may be generated using historical data of the user.

At step 305, the user interaction module 214 may instruct the user to perform at least one action related to the appliance corresponding to at least one of the plurality of causes. The user interaction module 214 may instruct the user to perform at least one action related to the appliance corresponding to at least one of the plurality of causes. The instructions provided to the user may be one of queries generated to the user and series of instructions provided to the user. The instructions are provided to the user based on one of at least one effect determined from the user input and a plurality of causes retrieved from the problem domain leading to the at least one effect. The instructions to be provided to the user may be retrieved dynamically from the database 104. Based on the instructions provided to the user, the user performs at least one action related to the appliance. The instructions may be provided to the user in the form of speech through a speaker associated with the assistance device 102 or may be displayed to the user via a display associated with the assistance device 102. Further, the user interaction module 214 may receive the user observations upon completion of the at least one action. The user observations may be received by the user interaction module in the form of text or speech via the I/O interface 201. Further, the user observations may also be monitored by one or more sensors associated with the assistance device 102. Considering the second instance, where the plurality of causes is determined to be “coil burning” and “washer burning”, the user interaction module 214 may instruct the user to “switch on mixer and inform if burning smell is perceived”. The user performs the action of switching the mixer to an “on” state and may check if burning smell is perceived. The user may provide his/her observation after completion of the task. In the above-mentioned scenario if the burning smell is perceived the user, the user may key in the observation as “yes”. The user interaction module receives the user observation. In an embodiment, if the user is deviating from the instructions provided to the user, the user interaction module 214 may prevent the user from deviating from actual steps and brings back the user to the right step. Consider an embodiment where the user interaction module 214 instructs the user to “switch on the main supply and check for an issue in a device”. The user may not turn on the main supply, rather turns on a peripheral supply and provides an observation of“no issue seen in the device”. The user observation module 214 may observe that the user has not turned on the main supply and the user interaction module 214 may further instruct the user to “turn on the main supply”, thereby, preventing the user from deviating from actual steps.

At step 306, the problem diagnosing module 215 may analyse the user observations for determining the actual cause of the problem from the plurality of causes corresponding to the at least one effect. Considering the second instance, the user observation is “yes” for the instruction “switch on mixer and inform if burning smell is perceived” provided by the user interaction module 214. The problem diagnosing module 215 analyses that the burning smell is perceived by the user with no load on the mixer. Thereby, based on the pre-learning the problem diagnosing module 215 diagnoses the problem to be “coil issue”.

In an embodiment, the assistance device 102 may retrieve the instructions to be provided to the user for performing a series of steps. When the user may have performed few steps among the series of steps, the assistance device 102 may dynamically determine a lead state (next step to be performed by the user based on a current state of the user) based on the user observations received and by monitoring the user actions. Based on the observations or outcome of the at least action performed by the user, the user is dynamically instructed to perform the further steps in the instructions.

In an embodiment, the assistance device 102 involves storing and using the additional information in the database 104 as a part of historical data (experience) that can be used for one or more other users with similar problems. The user, during the conversation with the assistance device 102, may provide additional information that helps in diagnosis. For an instance, while pulling a cable the user may also provide an input that there was a thunderstorm a day before. This crucial information may point to the damage in the power circuit due to surge. The LSTM model may be used to classify the user input to different categories. The information mentioned above may be added to the database 104 for formulating robust queries in future. Considering another instance, if another user is facing similar problem, the system may dynamically generate a query to the user “Was there a thunder storm last night?”. Based on the response from the user, the assistance device 102 may proceed further accordingly.

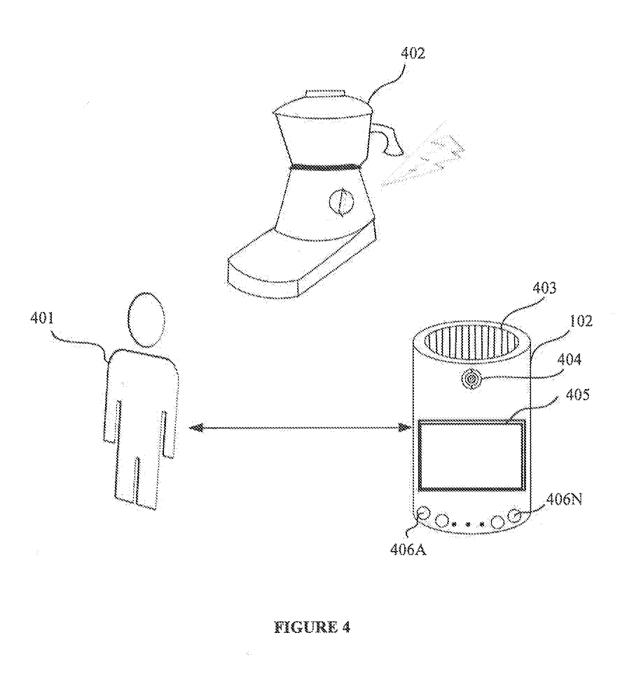

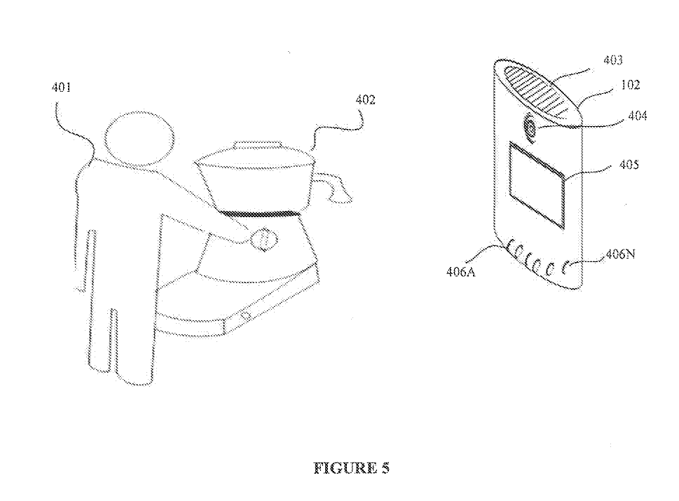

FIG. 4 and FIG. 5 illustrate exemplary embodiments for diagnosing problems in appliances, in accordance with some embodiments of the present disclosure

Illustrated FIG. 4 includes a user 401, an appliance 402 and the assistance device 102. The assistance device 102 includes a speaker unit 403, a camera unit 404, a touchpad unit 405 and a first sensor 406A, . . . , a nth sensor 406N. The first sensor 406A, . . . , the nth sensor 406N may be collectively represented as one or more sensors 406 in the present disclosure. As illustrated in FIG. 4, the appliance 402 is a mixer. The user 401 observes that a spark occurred in the appliance 402, as a result the user 401 perceives a burning smell. The user 401 consults the assistance device 102 for diagnosis of the problem faced by the user 401. The user 401 provides the user input to the assistance device 102 describing the problem faced. Considering the instance 1 where the user input is “Mixer not working, due to burning smell”. The assistance device 102 receives the user input through one of a microphone (included in the one or more sensors 406), camera 404 and the touchpad unit 405. The assistance device 102 parses the user input to generate one or more objects. The one or more objects extracted may be “mixer” and “burning smell”. At least one effect of the problem is determined from the extracted one or more objects. Considering the above-mentioned instance, “burning smell” is considered as the effect of the problem faced by the user. Further, the assistance device 102 determines “mixer” as the problem domain based on the one or more objects extracted. The determined problem domain is further used for determining the actual cause of the problem. Further, the assistance device further retrieves the plurality of causes from the database 104, leading to the at least one effect “burning smell”. The assistance module 102 traverses the problem domain of “mixer” to retrieve the plurality of causes leading to the determined at least one effect “burning smell”. The database 104 may have the plurality of causes leading to the effect of “burning smell”. The plurality of causes retrieved may be “coil burning” and “washer burning”.

Illustrated FIG. 5 includes the user 401, the appliance 402 and the assistance device 102. The assistance device 102 includes the speaker unit 403, the camera unit 404, the touchpad unit 405 and the one or more sensors 406. Upon determining the plurality of causes leading to the at least one effect, the assistance device instructs the user 401 to perform at least one action related to the appliance 401 corresponding to at least one of plurality of causes, as illustrated in FIG. 5. The user observations and actions are monitored by the one or more sensors 406 and the camera unit 404 associated with the assistance device 102. Table 1-Table 4 indicate four different instances for solving the problem mentioned in the instance 1 as defined by the user 401. Each of the four instances indicates a situation of diagnosing problem based on the user observations and monitoring of user actions. Table 1-Table 4 indicate conversation between the Assistance Device (AD) 102 and the user 401.

TABLE 1

| | |
|---|---|
| Instruction by AD 102: | switch on the mixer and tell if you get |
| | burning smell |
| Action by User 401: | switches on |
| Observation of User 401: | Yes |
| Result provided by AD 102: | coil issue |

Table 1 above indicates a first scenario where the user observations are considered by the AD 102. The AD 102 instructs the user to “switch on the mixer and tell if you get burning smell”. The user 401 turns on the mixer and provides an observation input of “yes” to the AD 102. The problem diagnosing module 215 analyses that the burning smell is perceived by the user with no load on the mixer. Thereby, based on the pre-learning the problem diagnosing module 215 diagnoses the problem to be “coil issue”.

TABLE 2

| | |
|---|---|
| Instruction 1 by AD 102: | switch on the mixer and tell if you get |
| | burning smell |
| Action by User 401: | switches on |
| Observation of User 401: | No |
| Instruction 2 by AD 102: | put some walnuts or hard stuff and check |
| Action by User 401: | User will put walnuts/hard item and |
| | checks |
| Observation by User 401: | Yes |
| Result provided by AD 102: | Washer issue |

Table 2 above indicates a second scenario where the user observations are considered by the AD 102. The AD 102 instructs the user to “switch on the mixer and tell if you get burning smell”. The user 401 turns on the mixer and provides an observation input of“no” to the AD 102, for instruction 1. The AD 102 further instructs the user to “put some walnuts or hard item and check” via instruction 2. The user puts a hard item, checks and provides an observation input of “yes” to the AD 102, for instruction 2. The problem diagnosing module 215 analyses that the burning smell is perceived by the user only with a load on the mixer. Thus, based on the pre-learning the problem diagnosing module 215 diagnoses the problem to be “washer issue”.

TABLE 3

| | |
|---|---|
| Instruction 1 by AD 102: | switch on the mixer and tell if you get |
| | burning smell |
| Action by User 401: | switches on |
| Observation of User 401: | No |
| Instruction 2 by AD 102: | put some walnuts or hard stuff and check |
| Action by User 401: | User 401 will put walnuts/hard item and |
| | checks |
| Observation by User 401: | No |
| Instruction 3 by AD 102: | Increase speed of the mixer and check |
| Action by User 401: | User 401 will increase speed of the mixer |
| Observation of user 401: | Yes |
| Result provided by AD 102: | Washer issue |

Table 3 above indicates a third scenario where the user observations are considered by the AD 102. The AD 102 instructs the user to “switch on the mixer and tell if you get burning smell”. The user 401 turns on the mixer and provides an observation input of“no” to the AD 102, for instruction 1. The AD 102 further instructs the user to “put some walnuts or hard stuff and check” via instruction 2. The user puts some hard stuff, checks and provides an observation input of “no” to the AD 102, for instruction 2. The AD 102 further instructs the user to “increase speed and check” via instruction 3. The user increases the speed, checks and provides an observation input of “no” to the AD 102, for instruction 3. The problem diagnosing module 215 analyses that the burning smell is perceived by the user only with a load on the mixer. Thereby, based on the pre-learning the problem diagnosing module 215 diagnoses the problem to be “washer issue”.

TABLE 4

| | |
|---|---|
| Instruction 1 by AD 102: | switch on the mixer and tell if you get |
| | burning smell |
| Action by User 401: | switches local knob |
| Monitoring by AD 102: | AD 102 observes that the main power |
| | is not ON. |
| Observation by User 401: | No |
| Instruction 2 by AD 102: | Please ensure power is ON |
| Action by User 401: | Switches on the main power |

Table 4 above indicates a fourth scenario where the AD 102 monitors the user 401 using the camera 404 and the one or more sensors 406 and prevents the user from deviating from the actual steps and brings back the user to the right step. The AD 102 instructs the user to “switch on the mixer and tell if you get burning smell” via instruction 1. The user 401 provides an observation of“yes” to the instruction 1. The AD 401 after monitoring provides a second instruction to the user 401 to “ensure the power is ON”. The user 401 performs an action of switching on the main power.

In an embodiment, the system and device as disclosed in the present disclosure, may be used for diagnosing problems in appliances adaptively. The system diagnoses real-time problem in appliances by interacting with the user.

In an embodiment, the system and device as disclosed in the present disclosure, learns dynamically based on the history of conversations.

In an embodiment, the system and device as disclosed in the present disclosure, may provide an efficient way for diagnosing the problem in appliances by monitoring the actions performed by the user via the camera and one or more sensors.

### Computer System

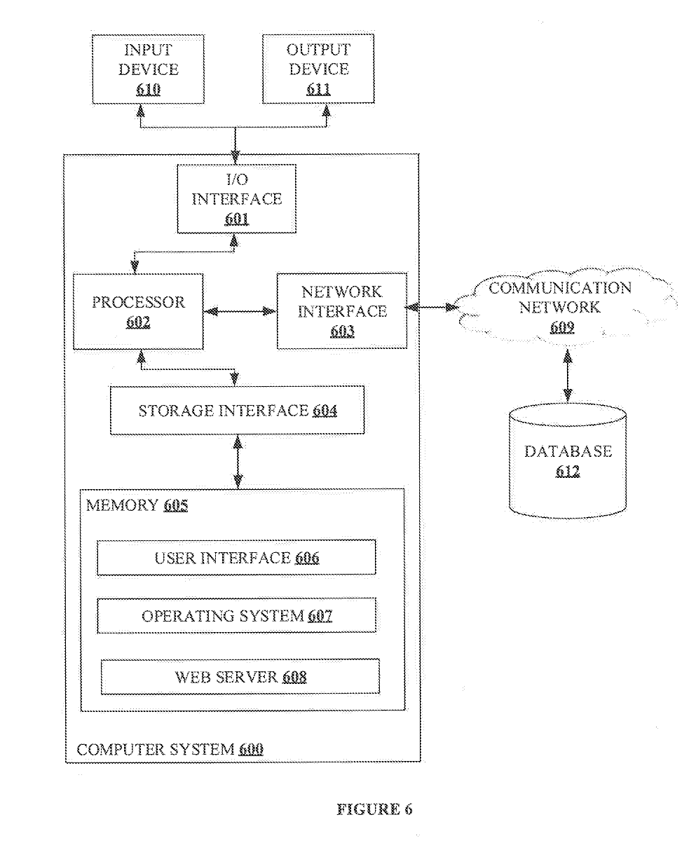

FIG. 6 illustrates a block diagram of an exemplary computer system 600 for implementing embodiments consistent with the present disclosure. In an embodiment, the computer system 600 is used to implement the assistance device 102. The computer system 600 may include a central processing unit (“CPU” or “processor”) 602. The processor 602 may include at least one data processor for executing program components for assisted diagnosis of problems in appliances. The processor 602 may include specialized processing units such as integrated system (bus) controllers, memory management control units, floating point units, graphics processing units, digital signal processing units, etc.

The processor 602 may be disposed in communication with one or more input/output (I/O) devices (not shown) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices. For example, the input device 610 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 611 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 600 is connected to the database 612 through a communication network 609. The processor 602 may be disposed in communication with the communication network 609 via a network interface 603. The network interface 603 may communicate with the communication network 609. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 609 may include, without limitation, a direct interconnection, local area network (LAN), wide area network (WAN), wireless network (e.g., using Wireless Application Protocol), the Internet, etc. Using the network interface 603 and the communication network 609, the computer system 600 may communicate with the knowledge graph 612 and the database 613. The network interface 603 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 609 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc. not shown in FIG. 7) via a storage interface 604. The storage interface 604 may connect to memory 605 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface 606, an operating system 607, web server 608 etc. In some embodiments, computer system 600 may store user/application data 606, such as, the data, variables, records, etc., as described in this disclosure. Such databases may be implemented as fault-tolerant, relational, scalable, secure databases such as Oracle® or Sybase@.

The operating system 607 may facilitate resource management and operation of the computer system 600. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLER IOS™, GOOGLE® ANDROID™, BLACKBERRY® OS, or the like.

In some embodiments, the computer system 600 may implement a web browser 608 stored program component. The web browser 608 may be a hypertext viewing application, for example MICROSOFT® INTERNET EXPLORER™, GOOGLE® CHROME™, MOZILLA® FIREFOX™, APPLER SAFARI™, etc. Secure web browsing may be provided using Secure Hypertext Transport Protocol (HITTPS), Secure Sockets Layer (SSL), Transport Layer Security (TLS), etc. Web browsers 608 may utilize facilities such as AJAX™, DHTML™, ADOBER FLASH™, JAVASCRIPT™, JAVA™, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP™, ACTIVEX™, ANST™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated method of FIG. 3 shows certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference number | Description |
|---|---|
| 100 | Environment |
| 101 | User Interface |
| 102 | Assistance device |
| 103 | Network |
| 104 | Database |
| 201 | I/O interface |
| 202 | Memory |
| 203 | Processor |
| 204 | Data |
| 205 | Object data |
| 206 | domain data |
| 207 | Appliance data |
| 208 | Other data |
| 209 | Modules |
| 210 | Communication module |
| 211 | Object extractor module |
| 212 | Problem domain determination module |
| 213 | Causes retrieval module |
| 214 | User interaction module |
| 215 | Problem diagnosing module |
| 216 | Other modules |
| 401 | User |
| 402 | Appliance |
| 403 | Speaker unit |
| 404 | Camera unit |
| 405 | Touchpad |
| 406 | One or more sensors |
| 700 | Computer System |
| 701 | I/O Interface of the exemplary Computer system |
| 702 | Processor of the exemplary Computer system |
| 703 | Network Interface |
| 704 | Storage Interface |
| 705 | Memory of the exemplary Computer system |
| 706 | User Interface of the exemplary Computer system |
| 707 | Operating System |
| 708 | Web Server |
| 709 | Communication Network |
| 710a, . . . , 710n | Input Devices |
| 711a, . . . , 711n | Output device |
| 712 | Database |

We claim:

1. A method for assisted diagnosis of problems in appliances, comprising:
receiving, by an assistance device, a user input describing a problem related to an appliance;
extracting, by the assistance device, one or more objects from the user input, wherein at least one effect of the problem is determined based on the one or more objects;
determining, by the assistance device, a problem domain from a plurality of problem domains based on the one or more objects;
retrieving, by the assistance device, a plurality of causes from the problem domain leading to the at least one effect;
instructing, by the assistance device, user to perform at least one action related to the appliance corresponding to at least one of the plurality of causes, wherein user observations are received upon completion of the at least one action; and
analysing, by the assistance device, the user observations for determining a cause from the plurality of causes corresponding to the at least one effect, for diagnosing the problem in appliances.

2. The method as claimed in claim 1, wherein the user input comprises at least one of text, speech, gestures, images and videos.

3. The method as claimed in claim 1, wherein extraction further comprises generating queries to the user based on the user input for extracting one or more objects from the user input.

4. The method as claimed in claim 1, wherein the one or more objects comprises at least one of a keyword and an image frame.

5. The method as claimed in claim 1, wherein each of the plurality of problem domains comprises information on problems related to each of one or more appliances, wherein the information comprises the plurality of causes corresponding to the at least one effect and the at least one action to be performed corresponding to the each of the plurality of causes.

6. The method as claimed in claim 1, wherein the user observations are at least one of inputs received from the user and inputs received from one or more sensors associated with the assistance device.

7. An assistance device for diagnosing problems in appliances, said assistance device comprising:
a processor; and
a memory, communicatively coupled with the processor, storing processor executable instructions, which, on execution causes the processor to:
receive, a user input describing a problem related to an appliance;
extract, one or more objects from the user input, wherein at least one effect of the problem is determined based on the one or more objects;
determine, a problem domain from a plurality of problem domains based on the one or more objects;
retrieve, a plurality of causes from the problem domain leading to the at least one effect;
instruct, user to perform at least one action related to the appliance corresponding to at least one of the plurality of causes, wherein user observations are received upon completion of the at least one action; and
analyse, by the assistance device, the user observations for determining a cause from the plurality of causes corresponding to the at least one effect, for diagnosing the problem in appliances.

8. The device as claimed in claim 7, wherein the user input comprises at least one of text, speech, gestures, images and videos.

9. The device as claimed in claim 7, wherein extraction further comprises generating queries to the user based on the user input for extracting one or more objects from the user input.

10. The device as claimed in claim 7, wherein the one or more objects comprises at least one of a keyword and an image frame.

11. The device as claimed in claim 7, wherein each of the plurality of problem domains comprises information on problems related to each of one or more appliances, wherein the information comprises the plurality of causes corresponding to the at least one effect and the at least one action to be performed corresponding to the each of the plurality of causes.

12. The device as claimed in claim 7, wherein the user observations are at least one of inputs received from the user and inputs received from one or more sensors associated with the assistance device.

13. A non-transitory computer readable medium including instructions stored thereon that when processed by at least one processor cause an assistance device to perform operation comprising:
receiving a user input describing a problem related to an appliance;
extracting one or more objects from the user input, wherein at least one effect of the problem is determined based on the one or more objects;
determining a problem domain from a plurality of problem domains based on the one or more objects;
retrieving a plurality of causes from the problem domain leading to the at least one effect;
instructing user to perform at least one action related to the appliance corresponding to at least one of the plurality of causes, wherein user observations are received upon completion of the at least one action; and
analysing the user observations for determining a cause from the plurality of causes corresponding to the at least one effect, for diagnosing the problem in appliances.

14. The medium as claimed in claim 13, wherein the user input comprises at least one of text, speech, gestures, images and videos.

15. The medium as claimed in claim 13, wherein extraction further comprises generating queries to the user based on the user input for extracting one or more objects from the user input.

16. The medium as claimed in claim 13, wherein the one or more objects comprises at least one of a keyword and an image frame.

17. The medium as claimed in claim 13, wherein each of the plurality of problem domains comprises information on problems related to each of one or more appliances, wherein the information comprises the plurality of causes corresponding to the at least one effect and the at least one action to be performed corresponding to the each of the plurality of causes.

18. The medium as claimed in claim 13, wherein the user observations are at least one of inputs received from the user and inputs received from one or more sensors associated with the assistance device.
